(19) United States
(12) Patent Application Publication
(10) Pub. No.: US 2013/0155079 A1
(43) Pub. Date: Jun. 20, 2013

(54) Saving and Restoring Shader Context State

(71) Applicants: Robert Scott HARTOG, Windemere, FL (US); Nuwan JAYASENA, Sunnyvale, CA (US); Mark LEATHER, Los Gatos, CA (US); Michael MANTOR, Orlando, FL (US); Rex McCRARY, Oviedo, FL (US); Kevin McGRATH, Los Gatos, CA (US); Sebastien NUSSBAUM, Lexington, MA (US); Philip J. ROGERS, Pepperell, MA (US); Ralph Clay TAYLOR, Deland, FL (US); Thomas R. WOLLER, Austin, TX (US)

(72) Inventors: Robert Scott HARTOG, Windemere, FL (US); Nuwan JAYASENA, Sunnyvale, CA (US); Mark LEATHER, Los Gatos, CA (US); Michael MANTOR, Orlando, FL (US); Rex McCRARY, Oviedo, FL (US); Kevin McGRATH, Los Gatos, CA (US); Sebastien NUSSBAUM, Lexington, MA (US); Philip J. ROGERS, Pepperell, MA (US); Ralph Clay TAYLOR, Deland, FL (US); Thomas R. WOLLER, Austin, TX (US)

(21) Appl. No.: 13/325,339

(22) Filed: Dec. 14, 2011

(51) Int. Cl. G06T 1/00

(52) U.S. Cl. 345/522

(57) ABSTRACT

Provided is a method for processing a command in a computing system including an accelerated processing device (APD) having a command processor. The method includes executing an interrupt routine to save one or more contexts related to a first set of instructions on a shader core in response to an instruction to preempt processing of the first set of instructions.

### BACKGROUND

1. Field of the Invention

The present invention is generally directed to computer systems. More specifically, the present invention is directed to saving and restoring the context state data during a context switching operation.

2. Background Art

The desire to use a graphics processing unit (GPU) for general computation has become much more pronounced recently due to the GPU's exemplary performance per unit power and/or cost. The computational capabilities for GPUs, generally, have grown at a rate exceeding that of the corresponding central processing unit (CPU) platforms. This growth, coupled with the explosion of the mobile computing market (e.g., notebooks, mobile smart phones, tablets, etc.) and its necessary supporting server/enterprise systems, has been used to provide a specified quality of desired user experience. Consequently, the combined use of CPUs and GPUs for executing workloads with data parallel content is becoming a volume technology.

However, GPUs have traditionally operated in a constrained programming environment, available primarily for the acceleration of graphics. These constraints arose from the fact that GPUs did not have as rich a programming ecosystem as CPUs. Their use, therefore, has been mostly limited to two dimensional (2D) and three dimensional (3D) graphics and a few leading edge multimedia applications, which are already accustomed to dealing with graphics and video application programming interfaces (APIs).

With the advent of multi-vendor supported OpenCL® and DirectCompute®, standard APIs and supporting tools, the limitations of the GPUs in traditional applications has been extended beyond traditional graphics. Although OpenCL and DirectCompute are a promising start, there are many hurdles remaining to creating an environment and ecosystem that allows the combination of a CPU and a GPU to be used as fluidly as the CPU for most programming tasks.

Existing computing systems often include multiple processing devices. For example, some computing systems include both a CPU and a GPU on separate chips (e.g., the CPU might be located on a motherboard and the GPU might be located on a graphics card) or in a single chip package. Both of these arrangements, however, still include significant challenges associated with (i) separate memory systems, (ii) efficient scheduling, (iii) programming model, (iv) compiling to multiple target instruction set architectures, and (v) providing quality of service (QoS) guarantees between processes, (ISAs)—all while minimizing power consumption.

For example, since processes cannot be efficiently identified and/or preempted in existing computing systems, a rogue process can occupy the GPU hardware for arbitrary amounts of time. This diminishes the user's QoS.

In other cases, the ability to context switch off of the hardware is severely constrained—occurring at very coarse granularity and only at a very limited set of points in a program's execution. This constraint exists because saving the necessary architectural and microarchitectural states for restoring and resuming a process is not supported. Lack of support for precise exceptions prevents a faulted job from being context switched out and restored at a later point, resulting in lower hardware usage as the faulted threads occupy hardware resources and which sit idle during fault handling.

GPU hardware can include a shader core, as well as non-shader resource components. The shader core includes an array of single instruction multiple data devices (SIMDs). Because SIMDs process multiple instructions simultaneously, the shader core context state can encompass up to several megabytes of data spread over registers and local data memory.

During operation, an external processor, reading and writing the shader core context state (which is required when saving and restoring GPU context state) can be severely limited by the external processor's own read/write capabilities. It can also be limited by the bandwidth between the external processor and the GPU. These two limitations can result in extremely long context switching times. This problem also exists for the other non-shader resource components associated with the GPU context state save and restore process.

### SUMMARY OF EMBODIMENTS

What is needed, therefore, are methods and systems that enable efficient CPU context state save and restore operations during CPU context switching applications.

Embodiments of the present invention, in certain circumstances, provide efficient GPU context switch operations for enhancing overall system operational speed. The present invention, in certain circumstances, also enables the offloading of applications from the CPU and so that the offloaded applications can be run on the CPU.

Although CPUs, accelerated processing units (APUs), and general purpose use of the graphics processing unit (GPCPU) are commonly used terms in this field, the expression “accelerated processing device (APD)” is considered to be a broader expression. For example, APD refers to any cooperating collection of hardware and/or software that performs those functions and computations associated with accelerating graphics processing tasks, data parallel tasks, or nested data parallel tasks in an accelerated manner compared to conventional CPUs, conventional CPUs, software and/or combinations thereof.

One embodiment of the present invention provides a system including a shader core configured to process a first set of instructions and a command processor configured for interrupting processing of the first set of instructions. The shader core is configured to save a context state associated with the first set of instructions after the interrupting, and process a second set of instructions after the context state has been saved.

Another embodiment provides a method including processing, by a shader core, a first set of instructions received from a command processor and interrupting processing of the first set of instructions via the command processor. The method also includes saving, by the shader core, a context state associated with the first set of instructions after the interrupting and processing a second set of instructions after the context state has been saved.

Additional features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1A is an illustrative block diagram of a processing system in accordance with embodiments of the present invention;

FIG. 1B is an illustrative block diagram of the APD illustrated in FIG. 1A;

FIG. 2 is a more detailed block diagram of the APD illustrated in FIG. 1B;

FIG. 3 is a flow chart of an exemplary method of practicing an embodiment of the present invention; and

FIG. 4 is flow chart of exemplary method of practicing another embodiment of the present invention.

### DETAILED DESCRIPTION OF EMBODIMENTS OF THE INVENTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

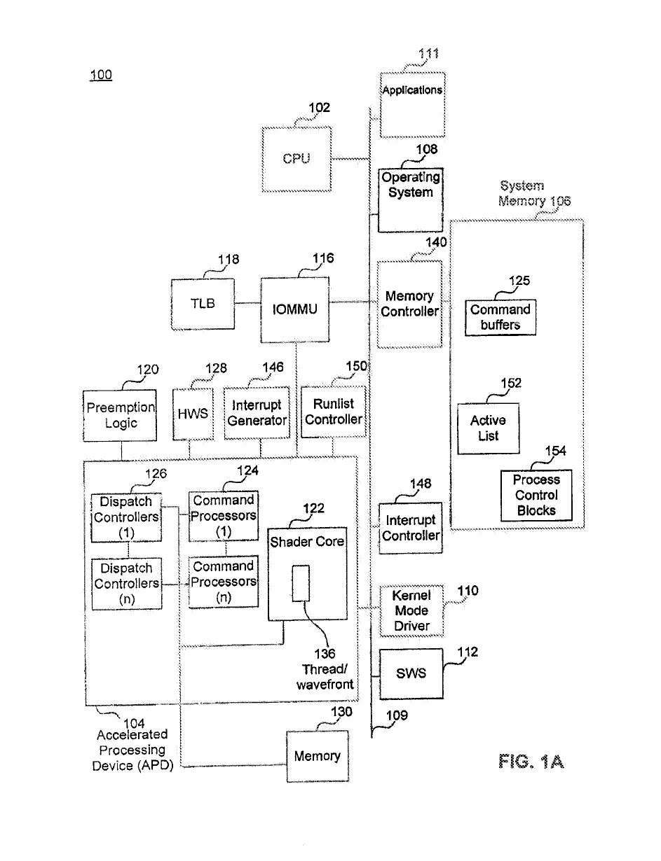

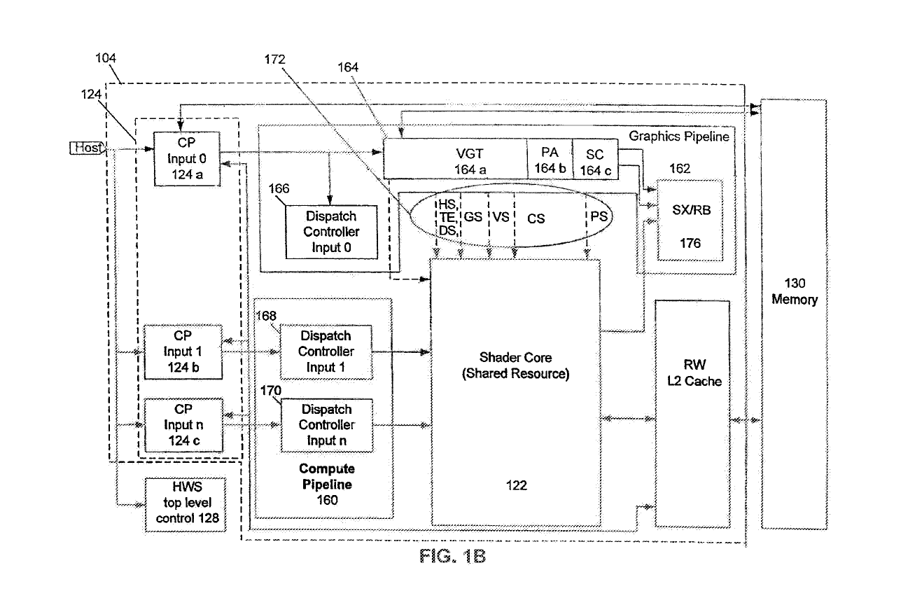

FIG. 1A is an exemplary illustration of a unified computing system 100 including two processors, a CPU 102 and an APD 104. CPU 102 can include one or more single or multi core CPUs. In one embodiment of the present invention, the system 100 is formed on a single silicon die or package, combining CPU 102 and APD 104 to provide a unified programming and execution environment. This environment enables the API) 104 to be used as fluidly as the CPU 102 for some programming tasks. However, it is not an absolute requirement of this invention that the CPU 102 and APD 104 be formed on a single silicon die. In some embodiments, it is possible for them to be formed separately and mounted on the same or different substrates.

In one example, system 100 also includes a memory 106, an operating system 108, and a communication infrastructure 109. The operating system 108 and the communication infrastructure 109 are discussed in greater detail below.

The system 100 also includes a kernel mode driver (KMD) 110, a software scheduler (SWS) 112, and a memory management unit 116, such as input/output memory management unit (IONIMU). Components of system 100 can be implemented as hardware, firmware, software, or any combination thereof A person of ordinary skill in the art will appreciate that system 100 may include one or more software, hardware, and firmware components in addition to, or different from, that shown in the embodiment shown in FIG. 1A.

In one example, a driver, such as KMD 110, typically communicates with a device through a computer bus or communications subsystem to which the hardware connects. When a calling program invokes a routine in the driver, the driver issues commands to the device. Once the device sends data back to the driver, the driver may invoke routines in the original calling program. Drivers are hardware-dependent and operating-system-specific. They usually provide the interrupt handling required for any necessary asynchronous time-dependent hardware interface.

Device drivers, particularly on modern Microsoft Windows® platforms, can run in kernel-mode (Ring 0) or in user-mode (Ring 3). The primary benefit of running a driver in user mode is improved stability, since a poorly written user mode device driver cannot crash the system by overwriting kernel memory. On the other hand, user/kernel-mode transitions usually impose a considerable performance overhead, thereby prohibiting user mode-drivers for low latency and high throughput requirements. Kernel space can be accessed by user module only through the use of system calls. End user programs like the UNIX shell or other GUI based applications are part of the user space. These applications interact with hardware through kernel supported functions.

CPU 102 can include (not shown) one or more of a control processor, field programmable gate array (FPGA), application specific integrated circuit (ASIC), or digital signal processor (DSP). CPU 102, for example, executes the control logic, including the operating system 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel operations, geometric computations, and rendering an image to a display. In various embodiments of the present invention, APD 104 can also execute compute processing operations (e.g., those operations unrelated to graphics such as, for example, video operations, physics simulations, computational fluid dynamics, etc.), based on commands or instructions received from CPU 102.

For example, commands can be considered as special instructions that are not typically defined in the instruction set architecture (ISA). A command may be executed by a special processor such a dispatch processor, command processor, or network controller. On the other hand, instructions can be considered, for example, a single operation of a processor within a computer architecture. In one example, when using two sets of ISAs, some instructions are used to execute ×86 programs and some instructions are used to execute kernels on an APD compute unit.

In an illustrative embodiment, CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited. to, one or more SIMD processing cores. As referred to herein, a SIMD is a pipeline, or programming model, where a kernel is executed concurrently on multiple processing elements each with its own data and a shared program counter. All processing elements execute an identical set of instructions. The use of predication enables work-items to participate or not for each issued command.

In one example, each APD 104 compute unit can include one or more scalar and/or vector floating-point units and/or arithmetic and logic units (ALUs). The APD compute unit can also include special purpose processing units (not shown), such as inverse-square root units and sine/cosine units, The APD compute units are referred to herein collectively as shader core 122.

Having one or more SIMDs, in general, makes API) 104 ideally suited for execution of data-parallel tasks such as those that are common in graphics processing.

Some graphics pipeline operations, such as pixel processing, and other parallel computation operations, can require that the same command stream or compute kernel be performed on streams or collections of input data elements. Respective instantiations of the same compute kernel can he executed concurrently on multiple compute units in shader core 122 in order to process such data elements in parallel. As referred to herein, for example, a compute kernel is a function containing instructions declared in a program and executed on an APD compute unit. This function is also referred to as a kernel, a shader, a shader program, or a program.

In one illustrative embodiment, each compute unit (e.g., SIMD processing core) can execute a respective instantiation of a particular work-item to process incoming data. A work-item is one of a collection of parallel executions of a kernel invoked on a device by a command. A work-item can be executed by one or more processing elements as part of a work-group executing on a compute unit.

A work-item is distinguished from other executions within the collection by its global ID and local ID. In one example, a subset of work-items in a workgroup that execute simultaneously together on a SIMD can be referred to as a wavefront 136. The width of a wavefront is a characteristic of the hardware of the compute unit (e.g., SIMD processing core). As referred to herein, a workgroup is a collection of related work-items that execute on a single compute unit. The work-items in the group execute the same kernel and share local memory and work-group barriers.

In the exemplary embodiment, all wavefronts from a workgroup are processed on the same SIMD processing core. Instructions across a wavefront are issued one at a time, and when all work-items follow the same control flow, each work-item executes the same program. Wavefronts can also be referred to as warps, vectors, or threads.

An execution mask and work-item predication are used to enable divergent control flow within a wavefront, where each individual work-item can actually take a unique code path through the kernel. Partially populated wavefronts can be processed when a full set of work-items is not available at wavefront start time. For example, shader core 122 can simultaneously execute a predetermined number of wavefronts 136, each wavefront 136 comprising a multiple work-items.

Within the system 100, APD 104 includes its own memory, such as graphics memory 130 (although memory 130 is not limited to graphics only use). Graphics memory 130 provides a local memory for use during computations in APD 104. Individual compute units (not shown) within shader core 122 can have their own local data store (not shown). In one embodiment, APD 104 includes access to local graphics memory 130, as well as access to the memory 106. In another embodiment, APD 104 can include access to dynamic random access memory (DRAM) or other such memories (not shown) attached directly to the APD 104 and separately from memory 106.

In the example shown, APD 104 also includes one or “n” number of command processors (CPs) 124. CP 124 controls the processing within APD 104. CP 124 also retrieves commands to be executed from command buffers 125 in memory 106 and coordinates the execution of those commands on APD 104.

In one example, CPU 102 inputs commands based on applications 111 into appropriate command buffers 125. As referred to herein, an application is the combination of the program parts that will execute on the compute units within the CPU and APD.

A plurality of command buffers 125 can be maintained with each process scheduled for execution on the APD 104.

CP 124 can be implemented in hardware, firmware, or software, or a combination thereof In one embodiment, CP 124 is implemented as a reduced instruction set computer (RISC) engine with microcode for implementing logic including scheduling logic.

APD 104 also includes one or “n” number of dispatch controllers (DCs) 126. In the present application, the term dispatch refers to a command executed by a dispatch controller that uses the context state to initiate the start of the execution of a kernel for a set of work groups on a set of compute units. DC 126 includes logic to initiate workgroups in the shader core 122. In some embodiments, DC 126 can be implemented as part of CP 124.

System 100 also includes a hardware scheduler (HWS) 128 for selecting a process from a run list 150 for execution on APD 104. HWS 128 can select processes from run list 150 using round robin methodology, priority level, or based on other scheduling policies. The priority level, for example, can be dynamically determined. HWS 128 can also include functionality to manage the run list 150, for example, by adding new processes and by deleting existing processes from run-list 150. The run list management logic of HWS 128 is sometimes referred to as a run list controller (RLC).

In various embodiments of the present invention, when HWS 128 initiates the execution of a process from RLC 150, CP 124 begins retrieving and executing commands from the corresponding command buffer 125. In some instances, CP124 can generate one or more commands to be executed within APD 104, which correspond with commands received from CPU 102. In one embodiment, CP 124, together with other components, implements a prioritizing and scheduling of commands on APD 104 in a manner that improves or maximizes the utilization of the resources of API) 104 and/or system 100.

APD 104 can have access to, or may include, an interrupt generator 146. Interrupt generator 146 can be configured by APD 104 to interrupt the operating system 108 when interrupt events, such as page faults, are encountered by APD 104. For example, APD 104 can rely on interrupt generation logic within IOMMU 116 to create the page fault interrupts noted above.

APD 104 can also include preemption and context switch logic 120 for preempting a process currently running within shader core 122. Context switch logic 120, for example, includes functionality to stop the process and save its current state (e.g., shader core 122 state, and CP 124 state).

As referred to herein, the term state can include an initial state, an intermediate state, and/or a final state. An initial state is a starting point for a machine to process an input data set according to a programming order to create an output set of data. There is an intermediate state, for example, that needs to be stored at several points to enable the processing to make forward progress. This intermediate state is sometimes stored to allow a continuation of execution at a later time when interrupted by some other process. There is also final state that can be recorded as part of the output data set.

Preemption and context switch logic 120 can also include logic to context switch another process into the API) 104. The functionality to context switch another process into running on the APD 104 may include instantiating the process, for example, through the CP 124 and DC 126 to run on APD 104, restoring any previously saved state for that process, and starting its execution.

Memory 106 can include non-persistent memory such as DRAM (not shown). Memory 106 can store, e.g., processing logic instructions, constant values, and variable values during execution of portions of applications or other processing logic. For example, in one embodiment, parts of control logic to perform one or more operations on CPU 102 can reside within memory 106 during execution of the respective portions of the operation by CPU 102.

During execution, respective applications, operating system functions, processing logic commands, and system software can reside in memory 106. Control logic commands fundamental to operating system 108 will generally reside in memory 106 during execution. Other software commands, including, for example, KMD 110 and software scheduler 112 can also reside in memory 106 during execution of system 100.

In this example, memory 106 includes command buffers 125 that are used by CPU 102 to send commands to APD 104. Memory 106 also contains process lists and process information (e.g., active list 152 and process control blocks 154). These lists, as well as the information, are used by scheduling software executing on CPU 102 to communicate scheduling information to APD 104 and/or related scheduling hardware. Access to memory 106 can be managed by a memory controller 140, which is coupled to memory 106. For example, requests from CPU 102, or from other devices, for reading from or for writing to memory 106 are managed by the memory controller 140.

Referring back to other aspects of system 100, IOMMU 116 is a multi-context memory management unit.

As used herein, context can be considered the environment within which the kernels execute and the domain in which synchronization and memory management is defined. The context includes a set of devices, the memory accessible to those devices, the corresponding memory properties and one or more command-queues used to schedule execution of a kernel(s) or operations on memory objects.

Referring back to the example shown in FIG. 1A, IOMMU 116 includes logic to perform virtual to physical address translation for memory page access for devices including APD 104. IOMMU 116 may also include logic to generate interrupts, for example, when a page access by a device such as APD 104 results in a page fault. IOMMU 116 may also include, or have access to, a translation lookaside buffer (TLB) 118. TLB 118, as an example, can be implemented in a content addressable memory (CAM) to accelerate translation of logical (i.e., virtual) memory addresses to physical memory addresses for requests made by APD 104 for data in memory 106.

In the example shown, communication infrastructure 109 interconnects the components of system 100 as needed. Communication infrastructure 109 can include (not shown) one or more of a peripheral component interconnect (PCI) bus, extended PCI (PCI-E) bus, advanced microcontroller bus architecture (AMBA) bus, advanced graphics port (AGP), or other such communication infrastructure. Communications infrastructure 109 can also include an Ethernet, or similar network, or any suitable physical communications infrastructure that satisfies an application's data transfer rate requirements. Communication infrastructure 109 includes the functionality to interconnect components including components of computing system 100.

In this example, operating system 108 includes functionality to manage the hardware components of system 100 and to provide common services. In various embodiments, operating system 108 can execute on CPU 102 and provide common services. These common services can include, for example, scheduling applications for execution within CPU 102, fault management, interrupt service, as well as processing the input and output of other applications.

In some embodiments, based on interrupts generated by an interrupt controller, such as interrupt controller 148, operating system 108 invokes an appropriate interrupt handling routine. For example, upon detecting a page fault interrupt, operating system 108 may invoke an interrupt handler to initiate loading of the relevant page into memory 106 and to update corresponding page tables.

Operating system 108 may also include functionality to protect system 100 by ensuring that access to hardware components is mediated through operating system managed kernel functionality. In effect, operating system 108 ensures that applications, such as applications 111, run on CPU 102 in user space. Operating system 108 also ensures that applications 111 invoke kernel functionality provided by the operating system to access hardware and/or input/output functionality.

By way of example, applications 111 include various programs or commands to perform user computations that are also executed on CPU 102. CPU 102 can seamlessly send selected commands for processing on the APD 104.

In one example, KMD 110 implements an application program interface (API) through which CPU 102, or applications executing on CPU 102 or other logic, can invoke APD 104 functionality. For example, KMD 110 can enqueue commands from CPU 102 to command buffers 125 from which APD 104 will subsequently retrieve the commands. Additionally, KMD 110 can, together with SWS 112, perform scheduling of processes to be executed on APD 104. SWS 112, for example, can include logic to maintain a prioritized list of processes to be executed on the APD.

In other embodiments of the present invention, applications executing on CPU 102 can entirely bypass KMD 110 when enqueuing commands.

In some embodiments, SWS 112 maintains an active list 152 in memory 106 of processes to be executed on APD 104. SWS 112 also selects a subset of the processes in active list 152 to be managed by HWS 128 in the hardware. Information relevant for running each process on APD 104 is communicated from CPU 102 to APD 104 through process control blocks (PCB) 154.

Processing logic for applications, operating system, and system software can include commands specified in a programming language such as C and/or in a hardware description language such as Verilog, RTL, or netlists, to enable ultimately configuring a manufacturing process through the generation of maskworks/photomasks to generate a hardware device embodying aspects of the invention described herein.

A person of skill in the art will understand, upon reading this description, that computing system 100 can include more or fewer components than shown in FIG. 1A. For example, computing system 100 can include one or more input interfaces, non-volatile storage, one or more output interfaces, network interfaces, and one or more displays or display interfaces.

FIG. 1B is an embodiment showing a more detailed illustration of APD 104 shown in FIG. 1A. In FIG. 1B, CP 124 can include CP pipelines 124a, 124b, and 124c. CP 124 can be configured to process the command lists that are provided as inputs from command buffers 125, shown in FIG. 1A. In the exemplary operation of FIG. 1B, CP input 0 (124a) is responsible for driving commands into a graphics pipeline 162. CP inputs 1 and 2 (124b and 124c) forward commands to a compute pipeline 160. Also provided is a controller mechanism 166 for controlling operation of HWS 128.

In FIG. 1B, graphics pipeline 162 can include a set of blocks, referred to herein as ordered pipeline 164. As an example, ordered pipeline 164 includes a vertex group translator (VGT) 164a, a primitive assembler (PA) 164b, a scan converter (SC) 164c, and a shader-export, render-back unit (SX/RB) 176. Each block within ordered pipeline 164 may represent a different stage of graphics processing within graphics pipeline 162. Ordered pipeline 164 can be a fixed function hardware pipeline. Other implementations can be used that would also be within the spirit and scope of the present invention.

Although only a small amount of data may be provided as an input to graphics pipeline 162, this data will be amplified by the time it is provided as an output from graphics pipeline 162. Graphics pipeline 162 also includes DC 166 for counting through ranges within work-item groups received from CP pipeline 124a. Compute work submitted through DC 166 is semi-synchronous with graphics pipeline 162.

Compute pipeline 160 includes shader DCs 168 and 170. Each of the DCs 168 and 170 is configured to count through compute ranges within work groups received from CP pipelines 124b and 124c.

The DCs 166, 168, and 170, illustrated in FIG. 1B, receive the input ranges, break the ranges down into workgroups, and then forward the workgroups to shader core 122.

Since graphics pipeline 162 is generally a fixed function pipeline, it is difficult to save and restore its state, and as a result, the graphics pipeline 162 is difficult to context switch. Therefore, in most cases context switching, as discussed herein, does not pertain to context switching among graphics processes. An exception is for graphics work in shader core 122, which can be context switched.

After the processing of work within graphics pipeline 162 has been completed, the completed work is processed through a render back unit 176, which does depth and color calculations, and then writes its final results to memory 130.

Shader core 122 can be shared by graphics pipeline 162 and compute pipeline 160. Shader core 122 can be a general processor configured to run wavefronts. In one example, all work within compute pipeline 160 is processed within shader core 122. Shader core 122 runs programmable software code and includes various forms of data, such as state data.

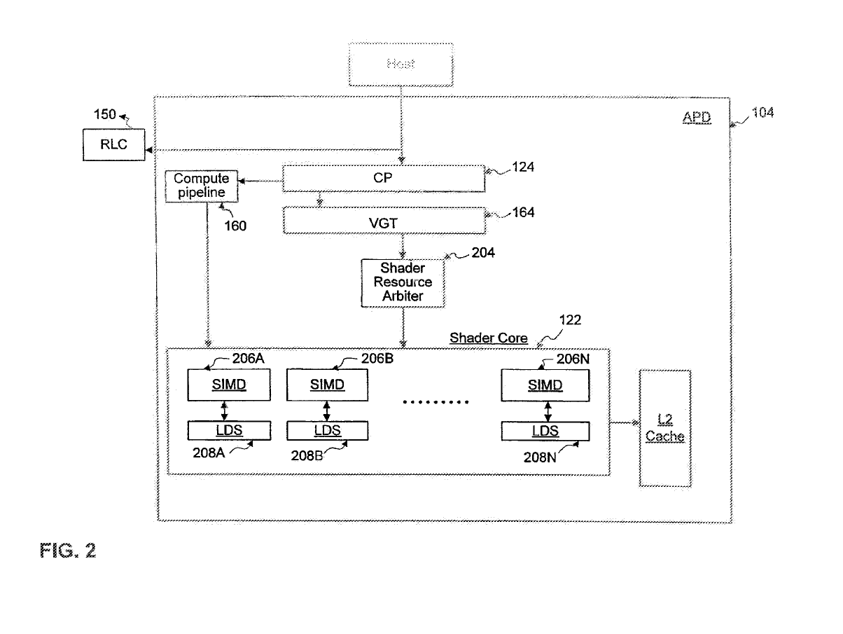

FIG. 2 is a block diagram showing greater detail of APD 104 illustrated in FIG. 1B. In the illustration of FIG. 2, APD 104 includes a shader resource arbiter 204 to arbitrate access to shader core 122. In FIG. 2, shader resource arbiter 204 is external to shader core 122. In another embodiment, however, shader resource arbiter 204 can be external to shader core 122. In a further embodiment, shader resource arbiter 204 can be included in graphics pipeline 162. Shader resource arbiter 204 can be configured to communicate with compute pipeline 160, graphics pipeline 162, or shader core 122.

Shader resource arbiter 204 can be implemented using hardware, software, firmware, or any combination thereof For example, shader resource arbiter 204 can be implemented as programmable hardware.

As discussed above, compute pipeline 160 includes DCs 168 and 170, as illustrated in FIG. 1B. The thread groups are broken down into wavefronts including a predetermined number of work-items. Each wavefront may include, for example, a shader program. The shader program is typically associated with a set of context state data. The shader program is forwarded to shader core 122 for shader core program execution.

CP 124 of APD 104 controls the execution or processing of a command buffer (or corresponding set of instructions) on the APD. During the execution of a command buffer on APD 104, the CP 124 dispatches respective groups of one or more instructions for processing on the shader core 122. The shader core may execute a compute kernal of respective groups of one or more instructions as workgroups.

During operation, each invocation of a shader program on a work-item has access to a number of general purpose registers (GPRs) (not shown), which are dynamically allocated in shader core 122 before running the program. When a workgroup is ready to be processed, shader resource arbiter 204 allocates the necessary GPRs. Shader core 122 is notified that a new workgroup is ready for execution and runs the shader core program on the wavefront.

As referenced in FIG. 1, APD 104 includes compute units, such as one or more SIMDs. In FIG. 2, for example, shader core 122 includes SIMDs 206A-206N for executing a respective instantiation of a particular work group or to process incoming data. SIMDs 206A-206N are respectively coupled to local data stores (LDSs) 208A-208N. LDSs 208A-208N to provide a private memory region accessible only by their respective SIMDs and is private to a work group. LDSs 208A-208N store the shader program context state data.

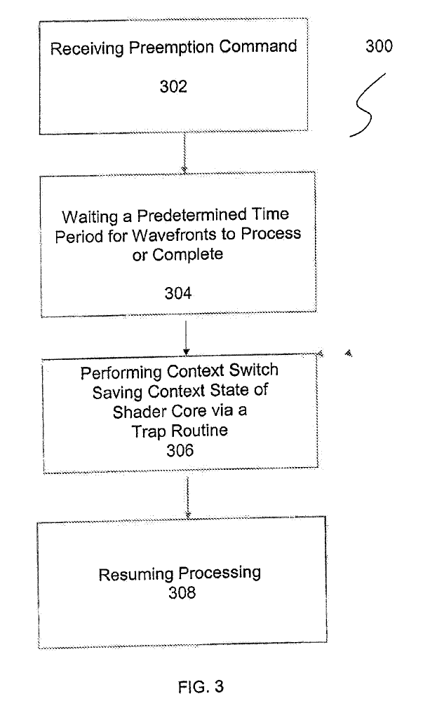

FIG. 3 is a flow chart 300 of an exemplary method of practicing an embodiment of the disclosed invention. Referring to FIG. 3, at operation 302, a trap routine is executed to save one or more context states related to a first set of instructions within a shader core, such as shader core 122. The executing is responsive to an instruction to preempt processing of the first set of instructions.

In operation 304, a second set of instructions is processed upon completion of the preemption of the first set of instructions.

In operation 306, processing of the first set of instructions resumes upon completion of the processing of the second set of instructions. Although FIG. 3 includes an illustration of the processing of two sets of instructions, the present invention is not limited to switching between two sets of instructions. Additionally, a given compute process need not be resumed, as in the case of a rogue process or a process discontinued by the operating system or discontinued by a user.

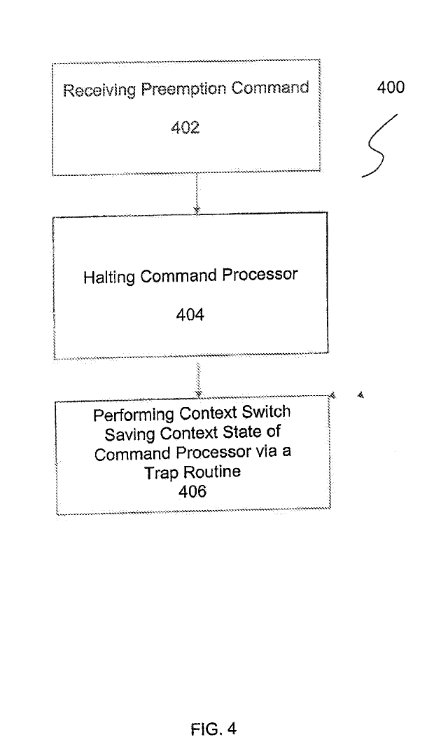

In another embodiment, as illustrated in FIG. 4, after receiving the preemption command (operation 402), the context state of the non-shader resources such as command processor 124, shader resource arbiter 204 and DCs 168, 170 also must be saved during a context switch operation. According to an embodiment, when the RLC 150 instructs CP 124 to stop processing commands (operation 404), CP 124 saves its own context state data, such as pointers, as well as the context state of other non-shader resources. This save process can be performed by the CP 124 executing an interrupt routine, such as a trap routine (operation 406).

After performing the context switch of a first program, and when the first program is to be restored to execute, the contents of the non-shader core resources must be restored. RLC 150 can signal CP 124 to begin the process of restoring its own context state from memory, as well as the context states of shader resource arbiter 204 and DCs 168, 170. After successful completion of the restore operation, CP 124 resumes fetching and processing of new commands of the restored first program.

In an alternative embodiment, instead of CP 124 instructing the compute pipeline DCs 168, 170 to suspend processing, upon receipt of a preemption command, the DCs continue launching wavefronts for the existing process until completed. All the wavefronts are saved via the trap routine. The DCs would not need to be saved/restored allowing processing of additional wavefronts.

### CONCLUSION

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for processing a command in a computing system including an accelerated processing device (APD) having a command processor, the method comprising:
responsive to an instruction to preempt processing of a first set of instructions, executing an interrupt routine to save one or more contexts related to the first set of instructions on a shader core.

2. The method of claim 1, wherein the interrupt routine is a trap routine.

3. The method of claim 1, wherein the one or more contexts include context of wavefronts implementing one or more of the first set of instructions.

4. The method of claim 3, wherein the one or more contexts include contexts of respective work-items of the wavefronts.

5. The method of claim 1, wherein the one or more contexts include contents of at least one of general purpose registers and local memory.

6. The method of claim 1, further comprising processing a second set of instructions upon completion of the preemption of the first set of instructions; and
resuming processing of the first set of instructions upon completion of the processing of the second set of instructions.

7. The method of claim 6, further comprising resuming processing of the first set of instructions from a point of preemption.

8. The method of claim 1, further comprising restoring the one or more contexts related to the first set of instructions.

9. The method of claim 1, wherein the instruction to preempt processing of the first instruction is transmitted via the command processor.

10. The method of claim 9, farther comprising transmitting the instruction to preempt processing of the first instruction to the shader core.

11. A computer readable media storing commands wherein said commands when executed are configured to process work-items on an accelerated processing device (APD) to perform a method for:
responsive to an instruction to preempt processing of a first set of instructions, executing an interrupt routine to save one or more contexts related to a first set of instructions on a shader core.

12. An apparatus, comprising:
a memory; and
an accelerated processing device (APD) coupled to the memory, wherein the APD is configured to, based on a command stored in the memory:
execute an interrupt routine to save one or more contexts related to a first set of instructions on a shader core in response to an instruction to preempt processing of the first set of instructions.

13. The apparatus of claim 12, wherein the interrupt routine is a trap routine.

14. The apparatus of claim 13, wherein the one or more contexts include context of wavefronts implementing one or more of the first set of instructions.

15. The apparatus of claim 14, wherein the one or more contexts include contexts of respective work-items of the wavefronts.

16. The apparatus of claim 15, wherein the one or more contexts include contents of at least one of general purpose registers and local memory.

17. The apparatus of claim 16, wherein the APD is further configured to process a second set of instructions upon completion of the preemption of the first set of instructions; and
resume processing of the first set of instructions upon completion of the processing of the second set of instructions.

18. The apparatus of claim 17, wherein the APD is further configured to resume processing of the first set of instructions from a point of preemption.

19. The apparatus of claim 18, wherein the APD is further configured to restore the one or more contexts related to the first set of instructions.

20. The apparatus of claim 19, wherein the APD includes a command processor and wherein the instruction to preempt processing of the first instruction is transmitted by the command processor.
